(19) United States
(12) Patent Application Publication
(10) Pub. No.: US 2010/0093333 A1
(43) Pub. Date: Apr. 15, 2010

(54) Systems and Methods for Providing Wireless Targeted Advertising

(75) Inventors: Robert H. Friedenthal, Encino, CA (US); David G. Thompson, West Hollywood, CA (US); Savalas O. Colbert, Beverly Hills, CA (US)

Correspondence Address: SHEPPARD, MULLIN, RICHTER & HAMPTON LLP, 990 Marsh Road, Menlo Park, CA, 94025, US

(73) Assignee: 411 Web Directory, Culver City, CA (US)

(21) Appl. No.: 12/564,009

(22) Filed: Sep. 21, 2009

Related U.S. Application Data
(60) Provisional application No. 61/104,236, filed on Oct. 9, 2008.
(60) Provisional application No. 61/110,551, filed on Nov. 1, 2008.
(60) Provisional application No. 61/119,335, filed on Dec. 2, 2008.

(51) Int. Cl. H04M 3/00; H04W 64/00; G06Q 30/00

(52) U.S. Cl. 455/418; 455/456.3; 705/1.1; 705/14.58; 455/466

(57) ABSTRACT

Systems and methods for providing promotional invitations are described. In various embodiments, a method comprises establishing an account for a user, receiving user preferences from the user, storing the user preferences within a server, receiving a promotional invitation from a business, storing the promotional invitation from the business, determining a position of the user and transmitting a promotional invitation to the user based on the position and the user preferences.

### PRIORITY CLAIM

This application claims benefit of U.S. provisional application Ser. No. 61/104,236, entitled “Real-Time Data Dynamically Generated and Communicated Over Network Devices in Relation to Geographical Location to Create a Societal Network,” filed on Oct. 9, 2008; U.S. provisional application Ser. No. 61/110,551, entitled “Systems and Methods for Providing Geography-Based Tours,” filed on Nov. 1, 2008; and U.S. provisional application Ser. No. 61/119,335, entitled “Globally Accessible On Demand Interactive Market Environment,” filed on Dec. 2, 2008, which are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to data retrieval over a network, and more particularly to providing wireless targeted advertisements and/or promotional invitations to users based, in part, on user preferences and/or user data.

### BACKGROUND

Businesses often wish to advertise to people to encourage them to purchase a product, purchase a service, or attend an event. Advertising, traditionally, however has been limited to publications, billboards, television, and radio. With the advent of the Internet, advertising has appeared on websites and has been directed to consumers' personal email accounts.

Unfortunately, consumers often receive advertising when they are less apt to act upon the opportunity. Spam filters and junk mail filters immediately delete many advertisements. Similarly, while browsing the web, a consumer may not even notice advertising on a web page.

Even if the consumer is interested in an advertisement, however, the consumer is often not in a position to act on the advertisement. For example, a consumer browsing an article on the CNN website may be interested in a trip to Disneyland, but not able or interested in clicking on the advertisement and committing to a purchase at that time.

When the consumer is actively shopping, running errands, or otherwise apt to act upon an opportunity, the consumer is less likely to be browsing the Internet or reading email. As a result, the consumer may not receive advertisements of interest when they are more likely to pursue the opportunity.

Further, advertising and marketing have failed to identify, with any relative precision, the consumer's immediate intentions to consume a specific product. Advertisements broadcast via text or SMS message, e-mail, internet banner ads, or other electronic messaging have had a limited ability to identify a consumer's immediate demands. The immediate values of advertising or marginal demand for advertising by businesses or producers have not been leveraged much precision. This leads to ineffective or inefficient advertising.

### SUMMARY

Systems and methods for providing promotional invitations are described. In various embodiments, a method comprises establishing an account for a user, receiving user preferences from the user, storing the user preferences within a server, receiving a promotional invitation from a business, storing the promotional invitation from the business, determining a position of the user and transmitting a promotional invitation to the user based on the position and the user preferences.

In some embodiments, the method may further comprise receiving behavioral information and associating the behavioral information with the user. Transmitting the promotional invitation may also be based on the behavioral information. Transmitting the promotional invitation may comprise transmitting a text message.

The promotional invitation may comprise an advertisement. The promotional advertisement may also comprise a coupon and/or discount code.

In various embodiments, the method may further comprise receiving first business rules from the business and transmitting the promotional invitation to the user may be further based on the business rules. The first business rules may comprise a predetermined distance to a store and transmission of the promotional invitation to the user may occur when the position of the user is within the predetermined distance to the store.

In some embodiments, the method may further comprise receiving second business rules from another business and prioritizing the first and second business rules. Prioritizing the first and second business rules may be based on a comparison of a first subscription of the business with a second subscription of the other business.

Further, the method may further comprise determining if the user is within a moving vehicle and selecting to transmit the promotional invitation to the user based, at least in part, on the determination if the user is within the moving vehicle.

In various embodiments, a system may comprise a user preference module, a business account module, and a transaction module. The user preference module may be configured to establish an account for a user, to receive user preferences from the user, and to store the user preferences. The business account module may be configured to receive a promotional invitation from a business and to store the promotional invitation. The transaction module may be configured to determine a position of the user and to transmit a promotional invitation to the user based on the position and the user preferences.

In some embodiments, a computer readable medium comprises instructions. The instructions are executable by a processor for performing a method. The method may comprise establishing an account for a user, receiving user preferences from the user, storing the user preferences within a server, receiving a promotional invitation from a business, storing the promotional invitation from the business, determining a position of the user and transmitting a promotional invitation to the user based on the position and the user preferences.

### BRIEF DESCRIPTION OF THE DRAWINGS

FIG. 1 is a block diagram of a network in accordance with some embodiments.

FIG. 2 is a block diagram illustrating details of an account server in accordance with some embodiments.

FIG. 3 is a block diagram illustrating details of an offer server in accordance with some embodiments.

FIG. 4 is a flow chart illustrating providing a promotional invitation to a user in accordance with some embodiments.

FIG. 5 is a flow chart illustrating collecting information about a user in accordance with some embodiments.

FIG. 6 is a flow chart illustrating the establishment of a business account with a business client in accordance with some embodiments.

FIG. 7 is a block diagram illustrating details of a digital device in accordance with some embodiments.

### DETAILED DESCRIPTION

The following description is provided to enable any person skilled in the art to make and use the invention(s) described. Various modifications to the embodiments are possible, and the generic principles defined herein may be applied to these and other embodiments and applications without departing from the spirit and scope of the disclosure. Thus, the description is not intended to be limited to the embodiments and applications shown, but is to be accorded the widest scope consistent with the principles, features and teachings disclosed herein.

In various embodiments, a consumer may possess a smart phone with a global positioning system (GPS) capable of identifying the position or location of the device. When the consumer is within a predetermined distance from a store, the smart phone may receive a message (e.g., text message or email) with a promotional invitation. The promotional invitation may comprise, for example, a coupon (e.g., discount code) and/or advertisement. The consumer may act upon the promotional invitation, enter the store, and make purchases.

Promotional invitations may be sent to a consumer based on a number of criteria. In one example, user preferences of the consumer are taken into account (e.g., the consumer indicates a preference for shoes and an aversion for sporting goods). The criteria may also include data collected about the consumer based on behavior. For example, a promotional opportunity may be directed to a consumer who has purchased selected goods in the past.

Further, promotional invitations may be provided to the consumer based on economic modeling. In one example, promotional invitations may be provided to a consumer based on inventory levels (e.g., shortages or overstock) of goods. Further, promotional invitations may be provided to the consumer based on location of the consumer, expected location of the consumer, and anticipated consumption. As a result, a favorable price may be timely reached between businesses and consumers.

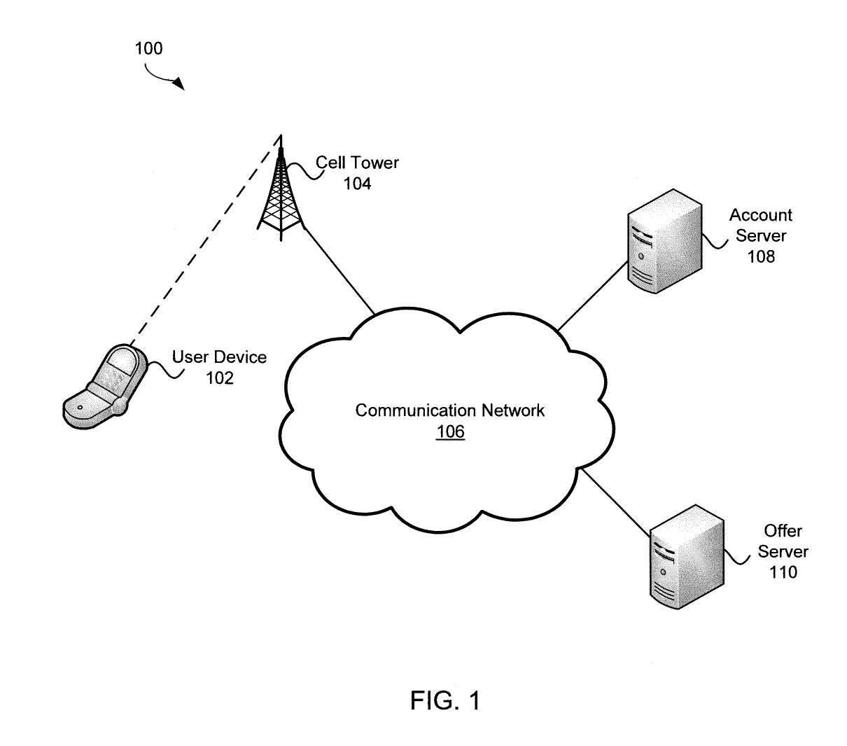

FIG. 1 is a block diagram of a network 100 in accordance with some embodiments of the present invention. The network 100 comprises a user device 102 configured to wirelessly communicate via a cell tower 104 with an account server 108 and an offer server 110 over a communication network 106.

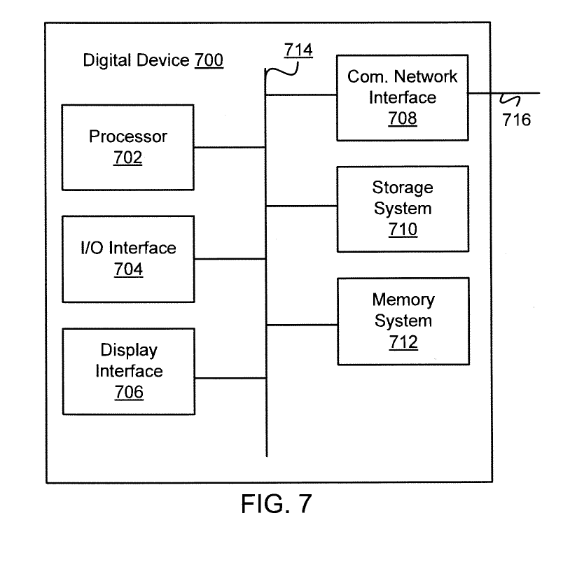

The user device 102 may comprise any device with a processor and memory capable of wireless communication. In some examples, the user device 102 is a digital device (see FIG. 7 discussed herein) such as a smart phone (e.g., Apple's iPhone or RIM's Blackberry), personal digital assistant (PDA), laptop, netbook, or other network-capable device configured to receive wireless data. In one example, the user device 102 is configured to receive a promotional invitation. A promotional invitation comprises information about a service, product, or event. In one example, the promotional invitation is an advertisement. The promotional invitation may also include a coupon or discount code that may be entered in making a purchase of a good, purchase of a service, or a ticket to an event. A promotional invitation may comprise, for example, html messages, text messages, email, MS Word documents, PDF documents, spreadsheets, images, movies, sound, flash animation, motion, and animation. A promotional invitation may include, for example, advertisements, notices, information about events, coupons, and offer for sale, or an invitation for an offer.

In various embodiments, the user device 102 wirelessly communicates with one or more other digital devices (e.g., the account server 108 and/or the offer server 110) over the cell tower 104. The cell tower 104 is any communication device configured to allow communication between the user device 102 and the communication network 106. In one example, the cell tower 104 is an AT&T 3G cell tower.

Optionally, the user device 102 may communicate with the communication network 106 via an access point. An access point, such as a wireless router, may be available at a hotspot such as a coffee shop, restaurant, hotel, or airport. In another example, the user device 102 may comprise a cellular phone and/or WiFi adapter from which communication may be established between the user device 102, the account server 108, and/or the offer server 110.

The communication network 106 may comprise any network or combination of networks that are communicatively coupled. In one example, the communication network 106 is the Internet. In another example, the communication network 106 is a local area network or a wide area network.

The account server 108 is a digital device configured to, in some embodiments, establish a user account, receive user preferences, track user behavior, and establish user rules that affect the type of promotional invitations to be provided as well as when and how promotional invitations are to be provided.

The user may provide user preferences to the account server 108. In one example, the user may indicate that the user would like to receive promotional discounts and/or advertisements for a particular good (e.g., electronics), service, and/or event. Similarly, the user may indicate that the user would not like to receive promotional discounts and/or advertisements for other goods (e.g., shoes), services, and/or events.

The account server 108 may establish rules based on the user preferences. For example, based upon the user preferences, the account server 108 may establish one or more rules that allow promotional invitations related to electronics, or other preferred goods, to be sent to the user but bars promotional invitations related to shoes or goods in which the user previously indicated that they are not interested.

The account server 108 may also track user behavior and create user rules related to the user behavior. In one example, the user may receive a promotional invitation for clothes at a particular store. The promotional invitation may include a discount or promotional code. If the user visits the clothing store and uses the discount code, the behavior may be tracked by the account server 108. In one example, the discount or promotional code may be a random generated alpha-numeric code generated by the account server 108. The discount or promotional code may be validated by a business client (e.g., store, credit card company, account server 108, or the offer server 110) and a credit issues based on the validation.

Based on the behavior, the account server 108 may also establish user rules that the user prefers a particular type, size, or color of clothes. Further, some users may receive more promotional invitations than others based on user behavior. In one example, one user may shop for clothes more often than other users and, as a result, may prefer to receive more promotional invitations.

Further, the account server 108 may establish user rules that govern when a promotional invitation is to be sent to a user. In one example, the user may establish a user rule that indicates that they are not interested in receiving promotional invitations for a period of time (e.g., 10:00 AM to 3:00 PM or for two hours from a current time) or on certain days (e.g., Mondays or Mondays through Fridays). The user may also indicate they are not interested in receiving promotional invitations unless they are within a predetermined distance (e.g., 100 feet) of a store related to a promotional invitation. Alternately, the user may establish a user rule that they are interested in receiving a promotional invitation related to events in and around the user's hometown, zip code, or city.

In some embodiments, the user may activate or deactivate one or more software and/or hardware components in order to receive promotional invitations or bar a promotional invitations from being received. In one example, the user may configure the user device 102 to activate the service to receive available promotional invitations. In another example, the user may configure the user device 102 to deactivate the service so that the user device 102 does not receive any promotional invitations. In some embodiments, the user may deactivate the service for a period of time (e.g., for two hours when the user is at a movie). In some embodiments, the user may identify specific stores from which they wish to receive promotional invitations. In some embodiments, the user may identify the stores from which promotional invitations are not desired.

The offer server 110 is a digital device configured to, in some embodiments, establish an account with a business client, receive business rules from a business client, store promotional invitations, provide promotional invitations to users based on the business rules and the user rules, and account for payment. In various embodiments, a new business client may establish a subscription for a service provided, at least in part, by the offer server 110. The service provided may comprise the delivery of promotional invitations to users with user devices 102.

A business client may establish business rules governing when a promotional invitation is to be provided by the client. For example, the rules may govern which promotional invitation of a group of promotional invitations is to be provided. In one example, a business client may create a business rule to deliver a promotional invitation with a discount code to users with a user preference to receive the business client's products. The business rule may also indicate that a promotional invitation without a discount code is to be provided to users whose user behavior indicates that they have shopped with the business client before but have not established a user preference for the business client.

Further, the business client may create a business rule that indicates the conditions when the promotional invitation is to be provided. For example, the business client may establish a business rule that indicates a user with a user preference for the business client or products supplied by the business client receive a promotional invitation when the user is within a predetermined distance from a store related to the business client. In another example, the business client may establish a business rule that indicates that a user will receive a promotional invitation once a week. The business client may also establish a business rule when a particular promotional invitation is to be provided to the user. For example, the business client may establish a rule that a promotional invitation for a certain good is to be offered to all users who prefer the business client or the good provided by the business client when the business client has overstocked that good.

Those skilled in the art will appreciate that the offer server 110 may provide one or more promotional invitations to one or more user devices 102 based on a variety of business rules that may dictate the promotional invitation provided as well as how and when the promotional invitation is to be provided.

In various embodiments, business clients may provide promotional invitations to the offer server 110. In one example, the business client prepares the language of the promotional invitation. The business client may provide any number of promotional invitations for the offer server 110 to provide to any number of users. Alternately, the offer server 110 may generate one or more promotional invitation. In another embodiment, the promotional invitation may be generated and later modified as needed by either the business client or the offer server 110.

The offer server 110 may also track payment for one or more business clients. In one example, the offer server 110 accounts for the number of promotional invitations provided to a user. The offer server 100 may also track if the user sees the promotional invitation (e.g., determines if the promotional invitation message was opened by the user) and/or acted upon (e.g., determines if the user entered a store or used a discount code). The offer server 110 may offer a single payment subscription model for all services, a multi-tier system that is priced based, for example, on the number of promotional invitations provided, whether the promotional invitations were seen, and whether the promotional invitations were acted upon, or a combination of both.

Although two servers are depicted as being coupled with the local area network 106, there may be any number of servers coupled to the local area network 106. In one example, a single server may perform the functions of the account server 108 and the offer server 110.

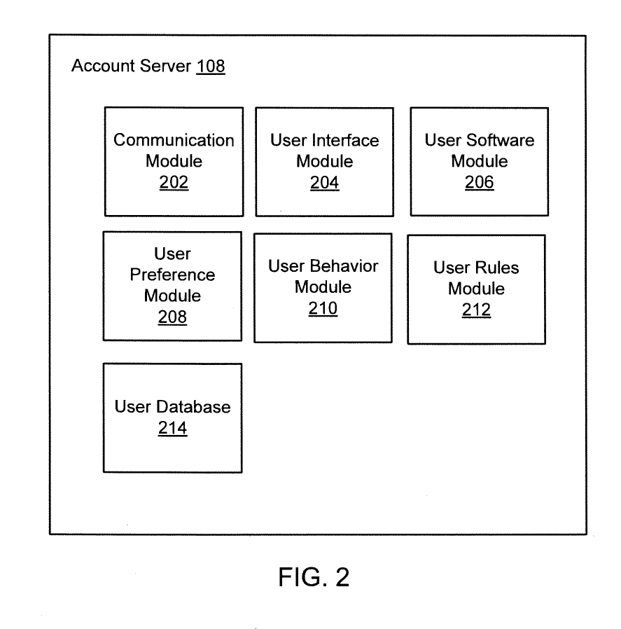

FIG. 2 is a block diagram illustrating details of an account server 108 in accordance with some embodiments. The account server 108 comprises a communication module 202, a user interface module 204, a user software module 206, a user preference module 208, a user behavior module 210, a user rules module 212, and a user database 214. The communication module 202 may be configured to provide communication between the account server 108, a user device 102, and/or the offer server 110. In some embodiments, the communication module 202 comprises a network interface card, a network interface driver, or a combination of both.

The user interface module 204 is configured to provide an interface to the user. The interface may comprise a graphical user interface. In one example, the user interface module 204 comprises a web server configured to provide the user with web pages that allow the user to register with the account server 108, set up an account, input user preferences, and establish user rules.

The user software module 206 is configured to provide the user device 102 with promotional invitation software configured to provide the offer server 110 location information and receive one or more promotional invitations. In one example, the user registers with the account server 108 with a user device 102. The user device 102 may be used to communicate with the account server 108 through an interface provided by the user interface module 204. After the user has been registered, the user software module 206 may provide the promotional invitation software to the user device 102.

The promotional invitation software provided to the user device 102 may be configured to provide location information and/or user behavioral information to the account server 108. In one example, the promotional invitation software may utilize a GPS device within the user device 102 to identify a location of the user device 102. The identified location may be provided to the account server 108 and/or the offer server 110. The promotional invitation software may also track goods, services, and events that are of interest to the user. For example, the promotional invitation software may track which web sites the user browses with the user device 102. The promotional invitation software may also track user actions if the user views a promotional invitation, retrieves a discount code, and/or utilizes a discount code. The tracked information may be sent to the account server 108, the offer server 110, or both.

The promotional invitation software may also be configured to display a promotional invitation to the user over the user device 102. In some embodiments, the promotional invitation software may comprise a message application such as an email application, SMS text application, and/or browser. In other embodiments, the promotional invitation software performs as an applet and works with an existing email application, SMS text application, and/or browser already on the user device 102. In one example, the promotional invitation software may generate a window in a browser to display one or more promotional invitations.

During establishment of the user account, the promotional invitation software may be stored within the user device 102. In one example, the promotional invitation software comprises executable instructions stored with a computer medium contained within the user device 102. The executable instructions are instructions that may be executed by a processor. The computer medium is any medium configured to store instructions (e.g., hard drive, tape, CD, or RAM). The executable instructions may associate the user device 102 with an identifier.

The user preference module 208 is configured to receive and store user preferences. In one example, as the user registers with the account server 108 and sets up an account, the user preference module 208 may provide a series of selectable options to the user. The user may indicate the types of goods, services, and/or events that the user is interested. The user may also provide preferences for when and how promotional invitations are received. In one example, the user may indicate that they prefer to receive promotional invitations only when walking in a city but not while driving or at home. In one example, the user may rate promotional items received in terms of value to the user (e.g., two thumbs down, one thumb up, three thumbs up, etc.). The user may also indicate a preference for receiving a promotional invitation via text message but not by email.

In various embodiments, the user may alter, update, or otherwise modify user preferences at any time. For example, after establishing an account, the user may log into the account server 108 to change the user preferences via the user preference module 208. The user preference module 208 may store the user preferences within the user database 214.

The user behavior module 210 is configured to track user behavior. In one example, promotional invitation software installed on the user device 102 by the user software module 206 provides the user behavior module 210 user behavioral information regarding the user's location or browsing habits. User behavioral information is information concerning the behavior of the user, including, for example, purchasing habits, travel plans, spending habits, products purchased, services purchased, and events attended. The user behavioral information may also include user demographics.

In one example, a promotional invitation with a promotion code is provided to the user. If the promotional invitation is viewed by the user, the promotional invitation software on the user device 102 may alert the user behavior module 210. If the user makes a purchase and indicates the promotion code (e.g., to receive a discount or free gift), the user behavior module 210 may also be alerted. The user behavior module 210 may store the user behavior information within the user database 214.

The user rules module 212 is configured to generate user rules associated with a user. In various embodiments, the user rules module 212 collect user preferences from the user preference module 208 as well as user behavioral information from the user behavior module 210 to generate user. The user rules may govern which promotional invitation is to be provided to the user, when the promotional invitation is to be provided to the user, and how. The user rules module 212 may store the user rules within the user database 214.

In various embodiments, the user rules module 212 generates rules based on one or more rules algorithms. The rules algorithms may weight information from the user preference module 208 and the user behavior module 210. In one example, a rules algorithm may weight user preferences from the user preference module 208 higher than user behavioral information from the user behavior module 210. Alternately, the rules algorithm may weight user behavioral information more than use preferences. Further, the weights may be positive or negative. In one example, a user preference may indicate a preference for skirts but an aversion to slacks, however, user behavioral information may indicate that the user has repeatedly purchased slacks over a long period of time. Consequently, the rules algorithm may heavily weight the user behavioral information (e.g., a preference for slacks and stores that sell slacks) but include a small negative weight based on the user preferences. As a result, a user rule may be generated that indicates that promotional invitations associated with slacks and business clients that sell slacks should be provided to the user.

The user database 214 is a data structure that is configured to store user information including user account information, as well as user preferences, user behavioral information, and user rules associated with the user. The data structure may be searchable and available to both the account server 108 and the offer server 110.

Those skilled in the art will appreciate that the account server 108 may comprise any number of modules. In one example, there may be fewer modules than those depicted in FIG. 2 which may perform the same functions and/or more functions as those described herein. In another example, there are more modules than those depicted in FIG. 2.

A module may comprise software, hardware, or a combination of both. Software comprises computer readable instructions able to be read and executed by a processor. The instructions may be contained within a computer readable media or medium which is described herein. Hardware may comprise logic, circuits, and/or firmware.

In various embodiments, demand curves and predicted demand values for consumers can be segmented or aggregated based on specific sets of user characteristics such as user preferences. Demand curves for each user set can be generated on demand and made accessible to business clients to suggest targeted price discrimination profiles for specific users.

Combining the demand curve with a user's personal purchase history and the user's preferences for goods, price discrimination can be implemented more precisely and specific consumer surplus profiles can be generated to aid business negotiation and advertising.

Below are simplified equations used to generate aggregate models of this nature that are enhanced by the segmentation of demographic profiles where P represents market price, Qₘₖₜ represents total quantity purchased, and CS represents consumer surplus when the demand for the maximum market price is zero.

$$C S = {\int }_{{P}_{mkt}}^{{P}_{max}} D ( p ) d P , \\ C S = \frac{1}{2} {Q}_{mkt} ( {P}_{max} - {P}_{mkt} )$$

Using aggregate models as standards of comparison, algorithms can be used on demand to adapt SQL statements to generate demand estimates for consumers with very specific preferences, demographics, and historical transaction trends. The resulting SQL statements may return specific result sets of data that match price discriminating profiles set by business clients.

The resulting transactions may provide a business client and user with purchasing and price setting information that has historically been widely unavailable.

One use of this technology will allow businesses and consumers alike to make more efficient use of their available capital and resources. This in turn has the potential to greatly increase standards of living and quality of production.

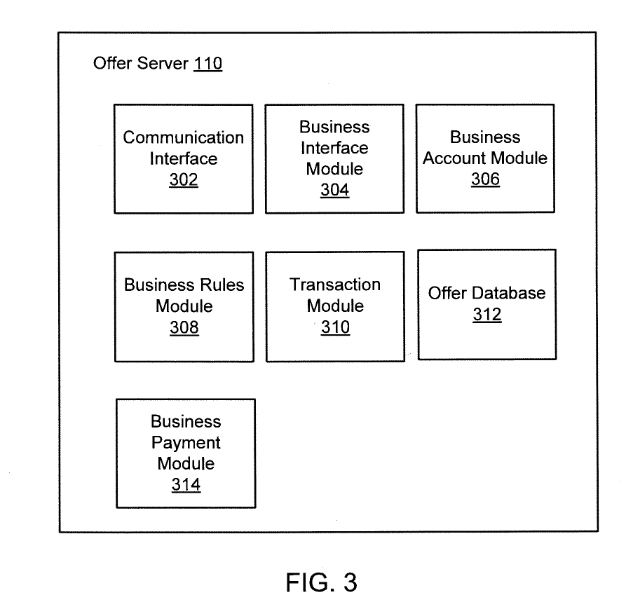

FIG. 3 is a block diagram illustrating details of an offer server 110 in accordance with some embodiments. The offer server 110 comprises a communication interface 302, a business interface module 304, a business account module 306, a business rules module 308, a transaction module 310, an offer database 312, and a business payment module 314.

The communication interface 302 may be configured to provide communication between the offer server 110, the user device 102, and the account server 108. In some embodiments, similar to the communication module 202 of the account server 108, the communication interface 302 comprises a network interface card, a network interface driver, or a combination of both.

The business interface module 304 is configured to provide an interface to a business client. A business client is any entity that is interested in providing a promotional invitation to one or more users. The interface may comprise a graphical user interface. In one example, the business interface module 304 comprises a web server configured to provide the business client with web pages that allow the business client to register with the offer server 110 and set up an account.

The business account module 306 is configured to allow a business client to establish a business account. In some embodiments, when establishing a business account, the business client may provide one or more promotional invitations to be provided to users as well as one or more business rules that govern the type of promotional invitation to be provided, how promotional invitations are to be provided, and when the promotional invitations are to be provided.

In various embodiments, the business account module 306 allows a business client to subscribe to a service to provide a promotional invitation to users. There may be various levels or qualities of service depending on the services required by the business client. In one example, the business client may subscribe to a premium level of service which allows the business client to provide a promotional invitation to a user and receive special treatment over another business client that subscribes to a lower level of service.

The business rules module 308 establishes business rules. In various embodiments, the business client provides various business rules to the business rules module 308. In other embodiments, the business account module 306 may provide the business client with a variety of predetermined options from which the business client may select. The business rules module 308 may then generate the business rules based on the selections.

In one example of a business rule, the business client may indicate that supplies for a particular good are high (e.g., overstocked). The business rules module 308 may generate a business rule to send a promotional invitation to all users within a predetermined distance of a store associate with the business client and/or all users with a user preference associated with the business client or the good.

In some embodiments, the business account module 306 tracks or receives inventory levels of one or more business clients. When inventory levels reach a predetermined level, the business rules module 308 may generate a business rule to send one or more promotional invitations to one or more users. Alternately, a business rule may be generated to stop a promotional invitation from being sent to users.

The business account module 306 may also alter a promotional invitation based on inventory levels. In one example, a user may be alerted that inventory levels for a particular good are low. The promotional invitation may further indicate that there may be limited time to purchase the item based on the inventory level. Those skilled in the art will appreciate that the business account module 306 may alter a promotional invitation in any number of ways depending on inventory levels and/or other facts. In one example, the business rules module 308 may provide a promotional invitation as a timely reminder that Christmas is only two weeks away and certain sales are available.

The transaction module 310 is configured to determine when and how a promotional invitation is to be provided as well as the type of promotional invitation. In various embodiments, the transaction module 310 determines when a promotional invitation is triggered. The transaction module 310 may review applicable user rules and business rules before sending one or more promotional invitations to a user device 102.

In various embodiments, the transaction module 310 receives location information from the promotional invitation software or hardware on a user device 102. When the user device 102 is within a predetermined distance of a business client with a subscription, the transaction module 310 may retrieve user preferences and user behavioral information associated with the user of the user device 102 from the user database 214. If the user preferences and/or the user behavioral information demonstrate an interest in the business client or the products of the business client, the transaction module 310 may then review applicable business rules. For example, the business rules may indicate that a user with an interest in the business client or products of the business client is to receive one type of promotional invitation (e.g., the promotional invitation includes a specific advertisement with a discount). The business rules may also indicate, however, that a user with only some interest in the business client based on user behavioral information may receive a different promotional invitation (e.g., the promotional invitation may include a different advertisement without a discount).

Those skilled in the art will appreciate that the transaction module 310 may review user rules, business rules, a combination of both user rules and business rules, or neither. Further, the transaction module 310 may be configured to override some or all business rules and/or user rules. In one example, one user preference may indicate that the user is not interested in shoes, however, the user behavioral information indicates that the user often buys shoes. As a result, a promotional invitation related to shoes may be sent to the user.

Further, the transaction module 310 may override a user rule with a business rule or override a business rule with a user rule. In one example, a user rule may indicate that the user is willing to receive a promotional invitation of a business sale when the user is within 1 mile of the store, however, an overriding business rule may indicate that the promotional invitation will only be provided to users who are within 100 feet of a store associated with the business client. Those skilled in the art will appreciate that the transaction module 310 may override any business rule or user rule.

In various embodiments, the transaction module 310 resolves conflicts between business rules of different business clients. In one example, a limited number of promotional invitations may be sent to a user during a period of time. When multiple business rules indicate that multiple promotional invitations are to be provided to the user (e.g., the user is at a mall that is within a predetermined distance to several business clients), the transaction module 310 may prioritize which business client is to provide a promotional invitation to the users as well as which promotional invitation to provide. For example, the transaction module 310 may base prioritization on the user preference, user rules, and/or user behavioral information. The transaction module 310 may also base prioritization in favor of the business client that subscribes to the highest level of service. Further, the transaction module 310 may base decisions related to prioritization on revenue generation for the owner of the service of providing promotional invitations to users.

In some embodiments, the offer server 110 may alter or customize the promotional invitation provided to the user. In one example, the offer server 110 may identify the user by name. In another example the offer server 110 may alter the promotional invitation to refer to past promotional invitations received by the user or refer to the current location of the user. Those skilled in the art will appreciate that a promotional invitation may be altered and updated by the business client, the offer server 110, or a combination of both in many ways.

The offer database 312 is any data structure configured to receive and store promotional invitations. Each business client may provide one or more promotional invitations. Alternately, the offer server 110 may generate a promotional invitation for the business client. In some embodiments, the offer database 312 and the user database 214 are the same database.

The business payment module 314 is configured to account for billing of different business clients. In some embodiments, a business client may pay a service provider based on the number of promotional invitations provided to users, the number of user which opened or saw the message, and/or the number of users that acted upon the message (e.g., made a purchase associated with the promotional invitation). In one example, promotional invitation software on the user device 102 alerts the business payment module 314 when the user receives a promotional invitation. The promotional invitation software may also indicate if the user saw the message by providing an indication to the business payment module 314 that the promotional invitation was opened or remained on a screen of the user device 102 over a predetermined period of time (e.g., 10 seconds). In some embodiments, the user may be asked to interact with a promotional invitation to indicate interest (E.G., hit a button to be taken to a web site or receive additional information regarding the promotional invitation). If the user interacts with the promotional invitation the promotional invitation software may alert the business payment module 314 which will account for the action. The business payment module 314 may also be configured to generate reports, analysis of promotional invitations, efficiency of advertising, and billing.

In some embodiments, the offer server 110 may receive information to indicate that the user is driving or otherwise traveling. In one example, multiple locations may be provided to the offer server 110 which determines that the user is travelling, for example, by car. Based on the information, the offer server 110 may anticipate where the user will be and prepare promotional invitations for goods, services, or events where the user will be.

In various embodiments, one business client may wish to send a promotional invitation to driving users (E.G., when the business client is associated with gasoline sales). Alternately, even if the user is within a predetermined distance of a store associated with a business client, the business client may have a business rule that dictates that a promotional invitation should not be provided.

Further, a user may search for geography-based tours. Systems and methods related to generating tours for users is further discussed in U.S. provisional application Ser. No. 61/110,551, entitled “Systems and Methods for Providing Geography-Based Tours,” filed on Nov. 1, 2008, which is hereby incorporated by reference. Based on the tour information, including where and when the user is supposed to be located in the future, the transaction module 310 may provide one or more promotional invitation related to goods, services, and events in and around the area(s) of the tour. In some embodiments, using the tour-based technology enables the offer server 110 not to obtain GPS information from the user.

Those skilled in the art will appreciate that the offer server 110 may comprise any number of modules. In one example, there may be fewer modules than those depicted in FIG. 3 which may perform the same functions and/or more functions as those described herein. In another example, there are more modules than those depicted in FIG. 3.

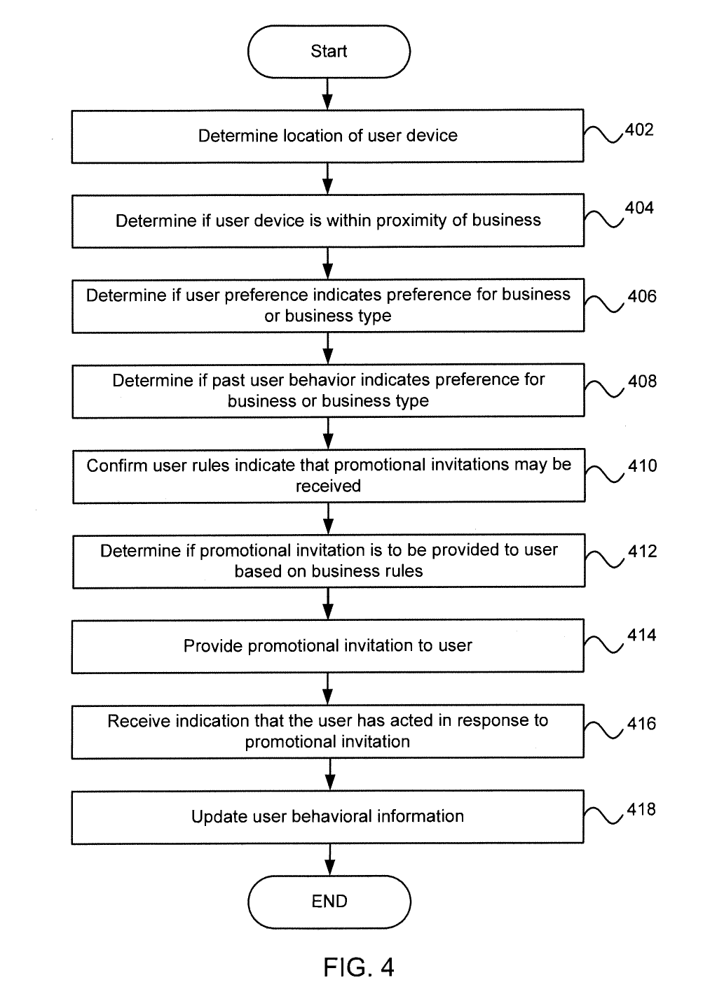

FIG. 4 is a flow chart illustrating providing a promotional invitation to a user in accordance with some embodiments. In step 402, the user device 102 determines the location of the user device 102. In one example, the user device 102 comprises a GPS device. In another example, the user device 102 may connect with one or more cell towers 104 to determine the location of the user device 102 and provide the location to the offer server 110. In some embodiments, promotional invitation software from the account server 108 that is installed on the user device 102 provides the location to the offer server 110. In some embodiments, a tour-based server provides its best guess of the user's location.

In step 404, the transaction module 310 determines if the user device 102 is within proximity of a business. In various embodiments, the transaction module 310 determines the distance between the location of the user device 102 and all places identified by registered business clients. In one example, a business client identifies all store fronts related to the business client. The transaction module 310 may determine the location between the user device 102 and all store fronts within a preset distance (e.g., within 2 miles).

In some embodiments, when a business client registers with the offer server 110, the business client may input a predetermined distance. When a user enters within the predetermined distance of a store or other business center, the business client may intend for the user device 102 to receive a promotional invitation. In one example, the predetermined distance if one business client is 20 feet from a store front while the predetermined distance of another business client is 40 feet from a store front.

In step 406, the transaction module 310 determines if a user preference associated with the user of the user device 102 indicates a preference for the business client or a type of business conducted by the business client. In one example, when the user registers with the account server 108, the user may identify preferred businesses (e.g., Banana Republic), type of preferred product, service, or event (e.g., shoes), and/or a type of business (e.g., clothing retail). In some embodiments, a user may identify a particular business, type of product or service, and/or type of business that the user does not prefer and may opt not to receive related promotional invitations.

In step 408, the transaction module 310 determines if past user behavior indicates a preference for the business, type of preferred product, service, or event, and/or type of business. In one example the transaction module 310 retrieves user behavioral information associated with the user from the account server 108 (e.g., the user behavior module 210 or the user database 214).

In step 410, the transaction module 310 confirms via the user rules module 212 of the account server 108 that the user rules indicate that a promotional invitation may be received by the user device 102. In one example, although the user may have a preference for a good, service, or event provided by a business client and the user device 102 is within a predetermined distance of a store of the business client, the user may have a user rule that indicates that the user device 102 is not to receive a promotional invitation for a period of time or for any other reason.

It will be apparent to those skilled in the art that, in some embodiments, like many other steps and components described herein, steps 406 and 408 are optional. In one example, the account server 108 may generate user rules based on the user preferences and the user behavioral information. The user rules may then be used to assist the transaction module 310 in determining if a promotional invitation is to be provided, the type of promotional invitation to provide, when the promotional invitation is to be provided, and how the promotional invitation is provided. In this example, the transaction module 310 only consults the user rules module 212 and not the user preference module 208 or the user behavior module 210.

In step 412, the transaction module 310 determines if the promotional invitation is to be provided to the user based on one or more business rules. As discussed herein, the business client may not wish to provide a promotional invitation unless a sale is occurring or a store is overstocked in an item. Those skilled in the art will appreciate that the business client may have any number of business rules affecting whether a promotional invitation is to be sent.

Similarly, the transaction module 310 may determine which promotional invitation to provide to the user device 102 based on the business rules. In one example, the business client may be a clothing apparel company. If the user has a preference for polo shirts, a business rule may indicate that a promotional invitation featuring polo shorts be provided to the user. In some embodiments, the transaction module 310 may select from a variety of promotional invitations provided by the business client and stored in the offer database 312. In other embodiments, the transaction module 310 may generate all or part of a promotional invitation based on information received from the business client, user preferences, or business rules, for example. In one example, the transaction module 310 may generate a text message highlighting preferred goods, services, or events associated with the business client.

Those skilled in the art will appreciate that there are many different ways the business rules may influence the type of promotional invitation to be provided to the user, when the promotional invitation is to be provided to the user, and how the promotional invitation is to be provided.

In step 414, the promotional invitation is provided to the user. In some embodiments, the promotional invitation is sent to promotional invitation software on the user device 102. The promotional invitation software may alert the user that a promotional invitation was received. In some examples, the alert may comprise sound, video, images, or any combination. The user may then choose to open the promotional invitation. The software may also display the promotional invitation directly on the user device 102 without alerting the user. In some embodiments, the alerts may be activated or deactivated by the user, the account server 108, and/or the offer server 110.

In step 416, the account server 108 and/or the offer server 110 receive an indication that the user has acted in response to the promotional invitation. In some embodiments, promotional invitation software on the user device 102 may track what promotional invitation the user opens and sends the information back to the account server 108 and/or the offer server 110.

In step 418, the user behavior module 210 updates the user behavior information. In one example, the user behavior module 210 tracks which promotional invitation has been sent to the user and if the user opened or otherwise interacted with the promotional invitation. The user behavior module 210 may also update the user behavior information if the user uses a coupon, discount code, or promotional number which was provided by the promotional invitation.

In one example, of providing promotional invitation to users, box office sales for a theatre may be strong, but begin to decline. Hoping to improve revenue, the box office may provide users with a promotional invitation comprising a 20% discount to users who are within a ½ mile of the theater.

Those skilled in the art will appreciate that a promotional invitation may be provided to users on behalf of hospitals and other service providers. In one example, a hospital may alert users to immediate wait times for urgent care, appointment scheduling, acceptable insurance policies, or specific types of care.

Further, a promotional invitation may be provided that advertise, in some examples, free educational programs, art exhibits, public library hours, public transportation schedules and traffic reporting, religious places of worship, public park hours, campground availability, public beach hours and crowd activity, crime reporting, and criminal activity levels for a local geographic area.

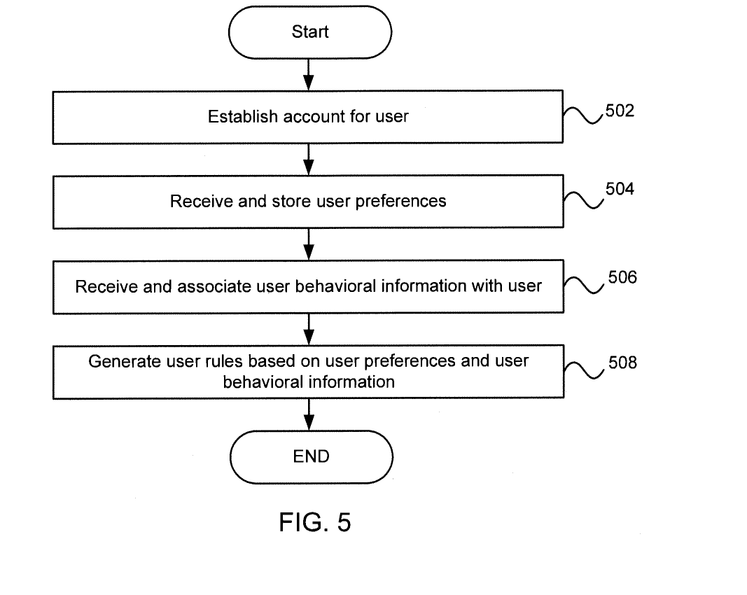

FIG. 5 is a flow chart illustrating collecting information about a user in accordance with some embodiments. In step 502, the account server 108 establishes an account for a user. In one example, the user accesses the account server 108 over the communication network 106 with the user device 102. The user interface module 204 may provide an interface such as a web page. The user may register with the account server 108 by selecting a username and password. In some embodiments, software may be stored on the user device 102 once registration is complete. Further, in various embodiments, all or some communication between the user device 102 and the account server 108 is encrypted.

In step 504, the user preference module 208 receives and stores user preferences with the user database 214. In some embodiments, the account server 108 establishes a record for each user. The user preferences and a user device 102 identifier may be stored within the record or otherwise associated with the user. The records may be stored within the user database 214.

In step 506, the user behavior module 210 may receive and associate user behavioral information with the user or user device 102. In one example, the user behavioral information may be stored within the record.

The user behavioral information collected by the user behavior module 210 may comprise, for example, previous purchases, past locations of the user device 102, past promotional invitations received, past promotional invitations seen, and/or browsing habits. In one example, past purchases of the user may be tracked by purchases that include a discount code or promotional number. The discount code or promotional number may have been originally provided by, in some examples, a promotional invitation, web site, business client, or store front.

The user behavioral information may also be collected based on the location of the user device 102. For example, the user device 102 may identify the location of the user device and provide the location to the user behavior module 210. Based on the location information, the user behavior module 210 may determine that the user resides in a particular area, frequents particular stores, visits selected facilities, travels often by airline, etc.

Further, the user behavioral information may also include the number of promotional invitations received and whether a promotional invitation was opened or seen by a user. In some embodiments, the user behavior module 210 may track the number of promotional invitations related to the purchase of shoes. If the user has not opened or seen any of the promotional invitations related to shoes, the user rules module 212 may generate a rule that the user does not prefer shoes (even if shoes are identified by the user preference module 208). Those skilled in the art will appreciate that the user behavioral information may be constantly updated.

In step 508, the user rules module 212 generates user rules based on user preferences and user behavioral information. In some embodiments, the user rules module 212 generates a user rule that indicates that a user is to be only sent promotional invitation for goods, services, and events that the user prefers (e.g., the user has established a user preference via the user preference module 208 or the user behavior module 210).

The user may also input specific user rules. In one example, the user may input a user rule that governs when a promotional invitation may be sent to the user. Further, the user may input a user rule that bars delivery of promotional invitations while the user device 102 is in certain locations. For example, a user may input a rule that limits promotional invitations while the user is at home, at work, visiting certain cities, in certain neighborhoods, or the like.

Those skilled in the art will appreciate that the user may alter, modify, or otherwise update information associated with the user and/or the user device. In various embodiments, the user may alter user preferences, input new user rules, modify old user rules, or cancel one or more user rules at any time.

In some embodiments, the user may indicate a willingness to receive an increased number of promotional invitations over other users. In one example, the user may register for a higher quality of service whereby additional promotional invitations may be provided to the user.

In return for receiving and/or acting upon a promotional invitation, a user may receive additional discounts, offers, or invitations to sales, for example, that other users may not receive. In one example, a user who often receives and acts on promotional invitations from Banana Republic may receive one or more additional promotional invitations including invitations to private events such as special sales or discounts.

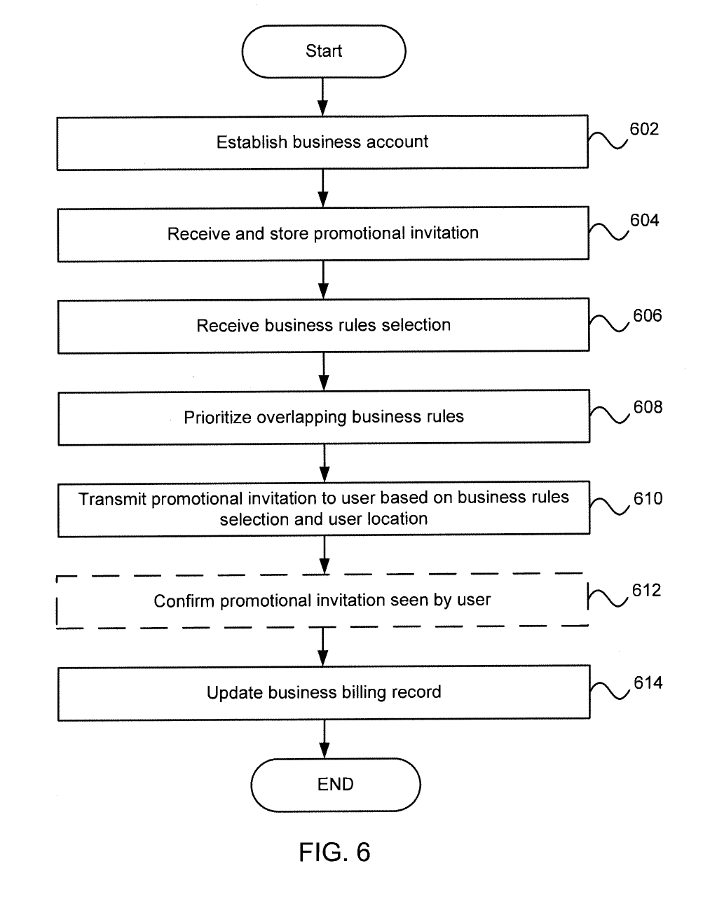

FIG. 6 is a flow chart illustrating interactions between a business client and the offer server 110 in accordance with some embodiments. In step 602, the business client establishes a business account with the offer server 110. In step 604, the offer database 312 receives and stores one or more promotional invitations. In various embodiments, the business client may design one or more promotional invitations. In one example, the business interface module 304 provides the business client with a variety of options to design, enter text, changing the appearance, or otherwise edit one or more promotional invitations. In another example, the business client creates their own promotional invitation and stores the promotional invitation in the offer database 312.

In step 606, the business rules module 308 may receive the business rules selection. In one example, the business rules module 308 provides the business client with a selection of predetermined rules to choose from. The business rules module 308 may also receive rules directly from the business client. In one example, the business client establishes a variety of business rules with the offer server 110 or account representatives when establishing a subscription for service. The business rules may then be programmed or otherwise input into the business rules module 308 to store within the user database 214.

In some embodiments, different business rules may relate to different promotional invitations of the same business client. In one example, if a user purchases a variety of products, the business client may have a business rule that indicates that a particular promotional invitation should be provided. If another user purchases only one kind of product, the business client may have another business rule that indicates that another promotional invitation should be provided. There may be any number of promotional invitations associated with any number of business rules.

In step 608, overlapping business rules are prioritized. In one example, multiple business rules may affect how and when a promotional invitation is provided to a user. In some embodiments, the business client prioritizes the rules and provides the priority to the business rules module 308. In other embodiments, the business rules each operate in turn unless there is a conflict. For example, one business rule dictates which promotional invitation to send to a user. Another business rule dictates the time when a promotional invitation is to be sent to a user. If the user qualifies to receive several promotional invitations at once from the same client, for example, multiple promotional invitations may be provided or, in some embodiments, a business rule may be suspended to limit the number of promotional invitations provided at one time. In various embodiments, when there are conflicts, the most recently received business rule may prevail over an older business rule.

In another example, multiple business rules from multiple business clients may conflict. In one example, one business rule of a first business client may dictate that only one promotional invitation may be sent to a user device 102 during a predetermined period of time (e.g., 5 minutes). However, another business rule of another business client may dictate that a promotional invitation should be sent immediately. In some embodiments, the business rules module 308 attempts to prioritize the business rules and alert the business clients of any conflicts so that the issues may be resolved.

In some embodiments, the business payment module 314 may prioritize or temporary suspend one or more business rules. In one example, one business client may pay for a higher level of service such that when conflicts with other business clients are created, the other business client's business rules are suspended. In another example, the business payment module 314 may determine which business client generates the highest revenue.

In step 610, the transaction module 310 provides the promotional invitation to the user based on the business rules selection and the user's location. In some embodiments, promotional invitations may be provided to the user regardless of location. In one example, promotional invitations may be sent to all users or sent to users with a preference for a good, service, or event related to the business client.

In optional step 612, the account server 108 and/or the offer server 110 confirms that the promotional invitation is seen by a user. In step 614, the business payment module 314 updates a business billing record. Those skilled in the art will appreciate that a business client may receive a report indicating which promotional invitations were sent, which promotional invitations were effective, and further analysis.

FIG. 7 is a block diagram illustrating details of a digital device 700 such as a user device 102 in some embodiments. The digital device 700 includes a processor 702, such as an Intel Pentium® microprocessor. In various embodiments, the processor 702 may comprise any number of cores, processors, and/or subprocessors. The digital device 700 further includes an I/O interface 704 configured to receive input from an input device such as a keyboard or mouse, a display interface 706 configured to be operatively coupled with a display such as a cathode ray tube display, a communications network interface 708, a data storage system 710 such as a magnetic disk, and a memory system 712 such as Random-Access Memory (RAM), each coupled to the communications channel 714. The communications network interface 708 may be coupled to a network such as the wide-area network commonly referred to as the Internet over the network link 716. In some embodiments, the network link 716 allows for wireless communication with a network. One skilled in the art will recognize that, although the data storage system 710 and memory system 712 are illustrated as different units, the data storage system 710 and memory system 712 can be parts of the same unit, distributed units, virtual memory, etc.

Computer readable media comprises any media that may store computer readable instructions (e.g., computer programs) that may be executed by a processor. In various embodiments, the data storage system 710 and the memory system 712 comprise computer readable media. The data storage system 710 and/or memory system 712 may store an operating system such as the Microsoft Windows XP, Linux, the IBM OS/2 operating system, the MAC OS, or UNIX operating system and/or other programs. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the digital device 700 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader such as a magnetic disk drive, hard disk drive, magneto-optical reader, etc. may be coupled to the communications channel 714 for reading a computer-readable storage medium (CRSM) such as a magnetic disk, a hard disk, a magneto-optical disk, RAM, etc. Accordingly, the digital device 700 may receive programs and/or data via the CRSM reader. Further, it will be appreciated that the term “memory” herein is intended to cover all data storage media whether permanent or temporary.

The foregoing description of the embodiments is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The embodiments are limited only by the following claims.

1. A method comprising:
establishing an account for a user;
receiving user preferences from the user;
storing the user preferences within a server;
receiving a promotional invitation from a business;
storing the promotional invitation from the business;
determining a position of the user; and
transmitting a promotional invitation to the user based on the position and the user preferences.

2. The method of claim 1, further comprising receiving user behavioral information and associating the user behavioral information with the user.

3. The method of claim 2, wherein transmitting the promotional invitation is further based on the user behavioral information.

4. The method of claim 1, wherein the promotional invitation comprises an advertisement.

5. The method of claim 1, wherein the promotional invitation comprises a coupon or discount code.

6. The method of claim 1, wherein transmitting the promotional invitation comprises transmitting a text message.

7. The method of claim 1, further comprising receiving first business rules from the business and wherein transmitting the promotional invitation to the user is further based on the business rules.

8. The method of claim 7, wherein the first business rules comprise a predetermined distance to a store and wherein transmitting the promotional invitation to the user occurs when the position of the user is within the predetermined distance to the store.

9. The method of claim 8, further comprising receiving second business rules from another business and prioritizing the first and second business rules.

10. The method of claim 9, wherein prioritizing the first and second business rules is based on a comparison of a first subscription of the business with a second subscription of the other business.

11. The method of claim 1, further comprising determining if the user is within a moving vehicle and selecting to transmit the promotional invitation to the user based, at least in part, on the determination if the user is within the moving vehicle.

12. A system comprising:
a user preference module configured to establish an account for a user, to receive user preferences from the user, and to store the user preferences;
a business account module configured to receive a promotional invitation from a business and to store the promotional invitation; and
a transaction module configured to determine a position of the user and to transmit a promotional invitation to the user based on the position and the user preferences.

13. The system of claim 12, further comprising a user behavior module configured to receive user behavioral information and to associate the user behavioral information with the user.

14. The system of claim 13, wherein the transaction module is further configured to transmit the promotional invitation further based on the user behavioral information.

15. The system of claim 12, wherein the promotional invitation comprises an advertisement.

16. The system of claim 12, wherein the promotional invitation comprises a coupon or discount code.

17. The system of claim 12, wherein the transaction module is configured to transmit the promotional invitation as a text message.

18. The system of claim 12, further comprising a business rules module configured to receive first business rules from the business and wherein the transaction module is further configured to transmit the promotional invitation to the user further based on the business rules.

19. The system of claim 18, wherein the first business rules comprise a predetermined distance to a store and wherein the transaction module is further configured to transmit the promotional invitation to the user when the position of the user is within the predetermined distance to the store.

20. The system of claim 19, wherein the business rules module is further configured to receive second business rules from another business and to prioritize the first and second business rules.

21. The system of claim 20, wherein the business rules module is further configured to prioritize the first and second business rules based on a comparison of a first subscription of the business with a second subscription of the other business.

22. The system of claim 12, wherein the transaction module is further configured to determine if the user is within a moving vehicle and to select whether to transmit the promotional invitation to the user based, at least in part, on the determination if the user is within the moving vehicle.

23. A computer readable medium comprising instructions executable by a processor for performing a method, the method comprising:
establishing an account for a user;
receiving user preferences from the user;
storing the user preferences within a server;
receiving a promotional invitation from a business;
storing the promotional invitation from the business;
determining a position of the user; and
transmitting a promotional invitation to the user based on the position and the user preferences.
